(19) United States
(12) Patent Application Publication
(10) Pub. No.: US 2026/0300743 A1
(43) Pub. Date: Oct. 1, 2026

(54) SYSTEMS AND METHODS FOR EVALUATING A LANGUAGE MODEL

(71) Applicant: Intuit Inc., Mountain View, CA (US)

(72) Inventors: Guy SHTAR, Nes-Ziona (IL); Aleksandr KIM, London (GB); Itay MARGOLIN, Petach Tikva (IL); Meghan MERGUI, Ramat Gan (IL); Jonathan Alexander RABIN, Kfar Saba (IL)

(21) Appl. No.: 19/090,022

(22) Filed: Mar. 25, 2025

(51) Int. Cl. G06N 3/09; G06N 3/045

(52) U.S. Cl. CPC G06N 3/09; G06N 3/045

(57) ABSTRACT

Certain aspects provide a method for evaluating a language model (LM). The method includes initializing an evaluator decision threshold value; for each respective evaluation input: providing the respective evaluation input to a first LM; receiving a respective evaluation output from the first LM; randomly selecting an evaluator decision value from a defined range of evaluator decision values; based on the randomly selected evaluator decision value being greater than or equal to the evaluator decision threshold value, providing the respective evaluation output to a second LM with a prompt to generate a respective label associated with the respective evaluation output; receiving, from the second LM, the respective label associated with the respective evaluation output; and decreasing the evaluator decision threshold value; and determining a performance score for the first LM based on a plurality of labels comprising the respective labels.

### BACKGROUND

### Field

Aspects of the present disclosure relate to systems and methods for evaluating a language model (LM).

### Description of Related Art

Generative artificial intelligence (GenAI) refers to machine learning models that are able to create new content based on patterns and information learned from training data in combination with a user prompt. The user prompt provides instruction to a model on what new content to generate and how to generate that new content. Notably, the model is able to generate new content based on both the actual information (e.g., facts, knowledge) included in the training data, as well as patterns, insights, and model parameter weights learned from the training data.

GenAI models are able to generate new content in many different forms, including text, image, audio, and even video. For example, to facilitate text generation, some GenAI models are configured as LMs. An LM is generally a type of machine learning model that is designed to understand, generate, and manipulate human language. More specifically, an LM is a probabilistic framework that determines the likelihood of a sequence of words or tokens. At its core, an LM attempts to predict the probability of the next word in a sentence given the preceding words. The LM estimates these probabilities based on the patterns it learned during training. LMs are useful in natural language processing (NLP) and computational linguistics for performing a range of tasks involving human language.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

LMs are often trained using large corpora of text. The training process involves adjusting the model's parameters to minimize the difference between its predicted word probabilities and the actual word sequences in the training data. This is typically done via techniques like maximum likelihood estimation and gradient descent. The training dataset used at this stage of training is typically configured as a general-purpose training dataset, such that the LM is trained to perform a wide range of tasks, including language understanding across many different knowledge domains. For example, LMs are trained on vast datasets that often include diverse and extensive sources of text from the Internet, books, articles, and various other textual corpora (e.g., domain-specific corpora). The large volume of training data contributes to their broad generalization capabilities.

While LMs represent a transformative force in many industries by assimilating vast amounts of knowledge, such as to build conversation-driven applications, these models are not without limitation. For example, while a powerful tool, a general-purpose LM may not be able to generate content and perform tasks related to specialized domains that were not represented in the original training data.

### SUMMARY

One aspect provides a method for evaluating an LM. The method includes initializing an evaluator decision threshold value; for each respective evaluation input of a plurality of evaluation inputs: providing the respective evaluation input to a first LM; receiving a respective evaluation output from the first LM; randomly selecting an evaluator decision value from a defined range of evaluator decision values; based on the randomly selected evaluator decision value being greater than or equal to the evaluator decision threshold value, providing the respective evaluation output to a second LM with a prompt to generate a respective label associated with the respective evaluation output; receiving, from the second LM, the respective label associated with the respective evaluation output; and decreasing the evaluator decision threshold value; and determining a performance score for the first LM based on a plurality of labels comprising the respective labels, each label of the plurality of labels being associated with an evaluation input of the plurality of evaluation inputs.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of a system for evaluating an LM.

FIG. 2 depicts another example of a system for evaluating an LM.

FIG. 3 depicts another example of a system for evaluating an LM.

FIG. 4 depicts another example of a system for evaluating an LM.

FIG. 5A depicts an example of a prompt for evaluating an LM.

FIG. 5B depicts an example of a transformed prompt for evaluating an LM.

FIG. 6 depicts a process flow for communications between an LM evaluation system, a first LM, and a second LM.

FIG. 7 depicts a method for evaluating an LM.

FIG. 8 depicts an example processing system with which aspects of the present disclosure can be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for evaluating a language model (LM).

Training for an LM, such as a small language model (SLM) or a large language model (LLM), typically starts with an untrained model (e.g., a model that has randomly initialized weights). The untrained model is trained to predict a next token given a sequence of previous tokens. In the context of LMs, tokens may be units of text that the models process and generate. Tokens can represent individual characters, words, subwords, or even larger linguistic units, depending on the specific tokenization (e.g., segmentation of text into meaningful units to capture its semantic and syntactic structure) approach used. Tokens act as a bridge between the raw text data and the numerical representations that LMs are able to process. Training data used to train an LM generally includes publicly available “raw text,” for example, from books, articles, websites, and/or the like. To be highly capable (e.g., have linguistic and world knowledge), this text may span a wide range of fields, genres, languages, etc. Eventually, training on large amounts of text, the model learns to encode the structure of language in general (e.g., it learns that “I like,” for example, may be followed by a noun or a participle) as well as the knowledge included in the raw text that the model was exposed to during training. Because the training data spans a wide variety of domains, these trained models are often referred to as general-purpose LMs.

Although a trained LM is, due to the knowledge it encodes, able to perform a variety of tasks, the model may lack specific knowledge that is not encoded in its training data. This knowledge may include (1) dynamic knowledge, (2) domain-specific knowledge, and/or (3) previously-acquired knowledge that has since been lost, to name a few. For example, dynamic knowledge refers to information that is constantly evolving, such as a user's age, an outstanding loan balance, stock prices, sensor data (e.g., such as from a thermostat inside a home), website analytics, and the like. Dynamic knowledge at a given point in time may become static and fail to evolve over time; thus, such knowledge encoded by the LM may become outdated.

Domain-specific knowledge (also referred to as “domain knowledge”) in machine learning (ML) refers to expertise and understanding of a specific field or subject matter (referred to herein as a “domain”) to which an ML model is applied. Accordingly, LMs may suffer from a domain knowledge deficit where they lack detailed, specialized knowledge for a particular domain, such as finance, healthcare, law, etc. in the base training dataset. For example, a general-purpose LM (e.g., an off-the-shelf LM) trained on publicly-available data may not be able to respond, or may respond incorrectly, to a domain-specific prompt, such as a prompt requesting information about a company's financial statements and/or accounts, a prompt requesting software code for an application, a prompt requesting information about employee retention at a particular company for a previous year, a prompt requesting customer help with an application and/or system internal to a company, and/or the like. The trained LM may not be able to respond, or may respond incorrectly, given the information that is requested is not part of a publicly available training data used to train the LM. Thus, in some cases, the trained LM, such as a general-purpose LM trained on publicly-available data, may not be ready or appropriate for a particular use case relating to a specific domain that the model is not trained on. Accordingly, the trained LM may need to be evaluated before the model is determined to be ready or appropriate for a particular use case (e.g., commercial deployment for a domain-specific use, such as providing a tax-related help or advice).

Conventional approaches for evaluating an LM to determine whether the model is ready or appropriate for a particular use case rely on a human (e.g., a domain expert) to evaluate whether a response from the LM based on an input is correct. The input may be referred to as a prompt, and when the prompt is for testing purposes, it may be referred to as an evaluation prompt. Certain technical problems or challenges exist for such conventional approaches to evaluating an LM, including delay associated with completing an evaluation (and thus approving an LM for a particular use case). For example, in the conventional approach described above, the human needs to read and understand each prompt, as well as a response from the LM for each prompt, in order to determine whether the response is correct. Since each iteration of such determination of whether a response is correct takes time to process, it would take an impractically long time to evaluate and approve an LM for a particular use case (e.g., based on multiple prompts and multiple responses). In some cases, it may not be feasible for the human to evaluate the LM completely (e.g., for all of the available samples to evaluate the LM with), much less to evaluate the LM completely within a given amount of time. Accordingly, when a human is to evaluate an LM, the efficiency in evaluating and approving the LM for a particular use case may be reduced based on the delay described above.

Such reduced efficiency may be exacerbated when the use case of the LM spans multiple domains. In some cases, the human that evaluates the LM may not be a domain expert for at least some of the multiple domains for which the LM outputs are being tested. Accordingly, it is technically impractical for a single domain expert to evaluate the LM outputs for multiple domains, and logistically impractical for multiple experts to be coordinated to test LM outputs across many domains.

Certain aspects described herein overcome the aforementioned technical problems and challenges, for example, by providing an adaptive evaluation system designed to ensure that an LM can be practically evaluated for use cases across various technical domains. In certain aspects, the adaptive evaluation system relies initially on human evaluators and gradually decreases dependence on human evaluators by shifting the evaluation burden to an evaluation LM. This dynamic system therefore has the benefits of human evaluators as well as the efficiency and wide domain knowledge of an LM evaluator. This dynamic evaluation system may thus be referred to as a hybrid or dual-system evaluation architecture. In this dynamic evaluation system, as the dependence on human evaluators decreases, the evaluation of an LM for use cases across various technical domains becomes more practical.

Aspects described herein provide various beneficial technical effects and/or advantages compared to conventional systems, including improved evaluation efficiency and accuracy across many technical domains. Certain aspects enable the evaluation of an LM more practical (e.g., when compared to conventional systems). For example, certain aspects described herein overcome the impracticality of using a human to evaluate an LM over a large set of domains, which would require many domain experts to assess the LM's output. Thus, the decrease of dependence on human evaluators and the shifting of evaluation burden to an evaluation LM in the aspects described herein alleviate the technical impracticality of the conventional systems for evaluating an LM over a large set of domains (e.g., using a single domain expert).

### Example Systems for Evaluating a Large Language Model

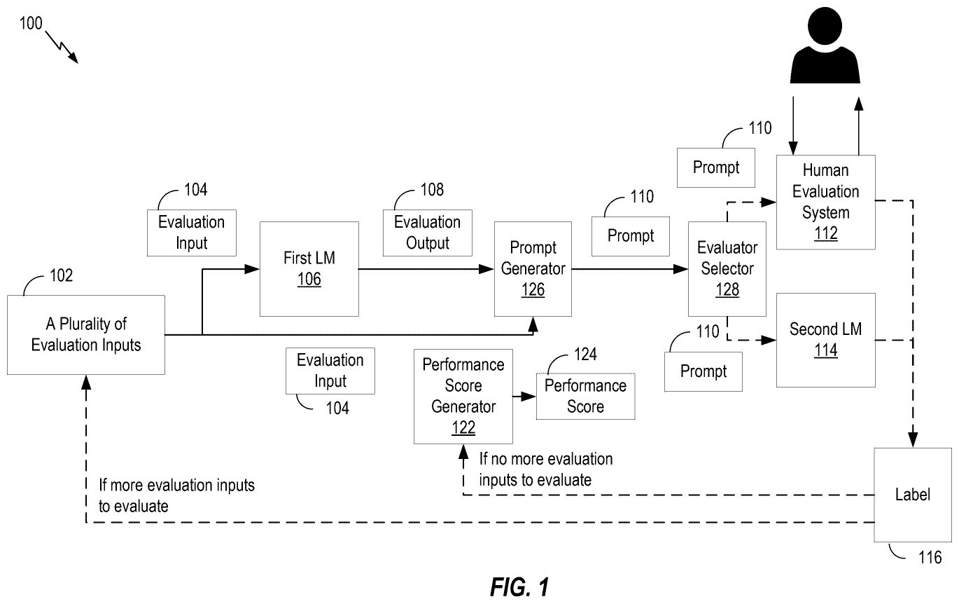

FIG. 1 depicts an example of a system 100 for evaluating an LM. As depicted, the example of FIG. 1 provides a plurality of evaluation inputs 102. Here, the plurality of evaluation inputs 102 are evaluation inputs to provide to an LM for the purpose of evaluating the LM. The evaluation inputs may be provided to the LM as part of or as a prompt that prompts the LM to provide an output. The output provided by the LM in response to an evaluation input may be referred to as an evaluation output (e.g., evaluation output 108). The evaluation inputs and the evaluation outputs are used to evaluate the LM (e.g., based on whether an evaluation output is a correct output for a given evaluation input). Each evaluation input 104 of the plurality of evaluation inputs 102 is provided to a first LM 106, and the first LM 106 generates an evaluation output 108 based on the evaluation input 104. In certain aspects, the first LM 106 may be a general-purpose LM. In some aspects, the first LM 106 may be an LM trained on a dataset that spans one or more domains.

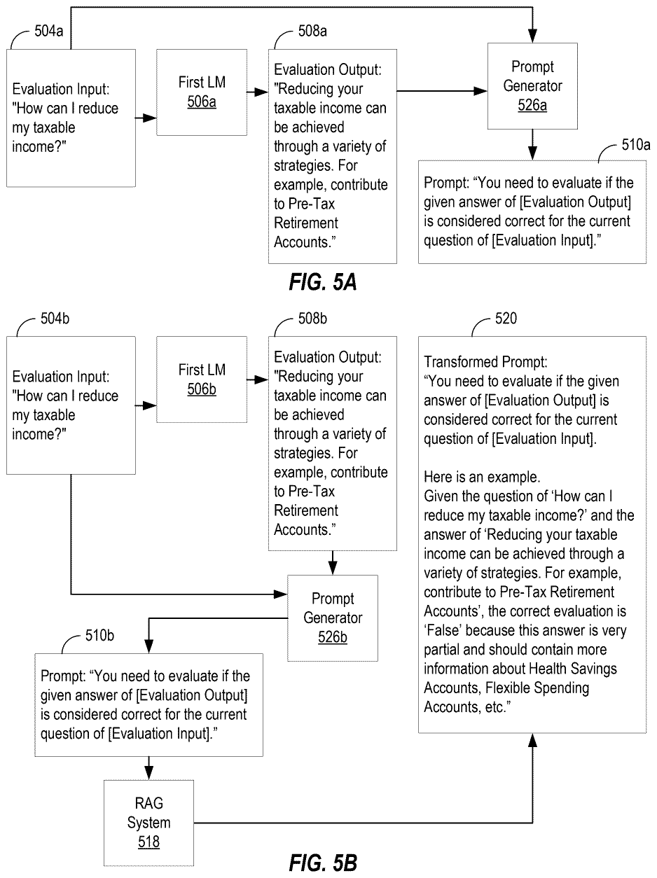

The evaluation output 108 from the first LM 106 and the evaluation input 104 are provided to a prompt generator 126. The prompt generator 126 generates a prompt 110 based on the evaluation input 104 and the evaluation output 108. For example, the prompt 110 may include an instruction to evaluate whether the evaluation output 108 is correct given the evaluation input 104, where, as just one example, the evaluation input 104 may be a text including multiple sentences, and the evaluation output 108 may be a one-sentence summary of the text of the evaluation input 104. Other types of evaluation input 104 and evaluation output 108 are also possible. The prompt generator 126 provides the prompt 110 to an evaluator selector 128, which provides the prompt 110 to a human evaluation system 112 or a second LM 114 to evaluate whether the evaluation output 108 is considered correct for the evaluation input 104. Additional examples of the evaluation input 104 and the evaluation output 108 are described further herein with respect to FIGS. 5A and 5B. In certain aspects, the human evaluation system 112 may be a computing system (e.g., including one or more processors and one or more memories) that provides an interface for a human (e.g., a domain expert) to evaluate the evaluation output 108 given the evaluation input 104. In some aspects, the second LM 114 may be a general-purpose LM or an LM trained or fine-tuned to evaluate an LM response given an evaluation input.

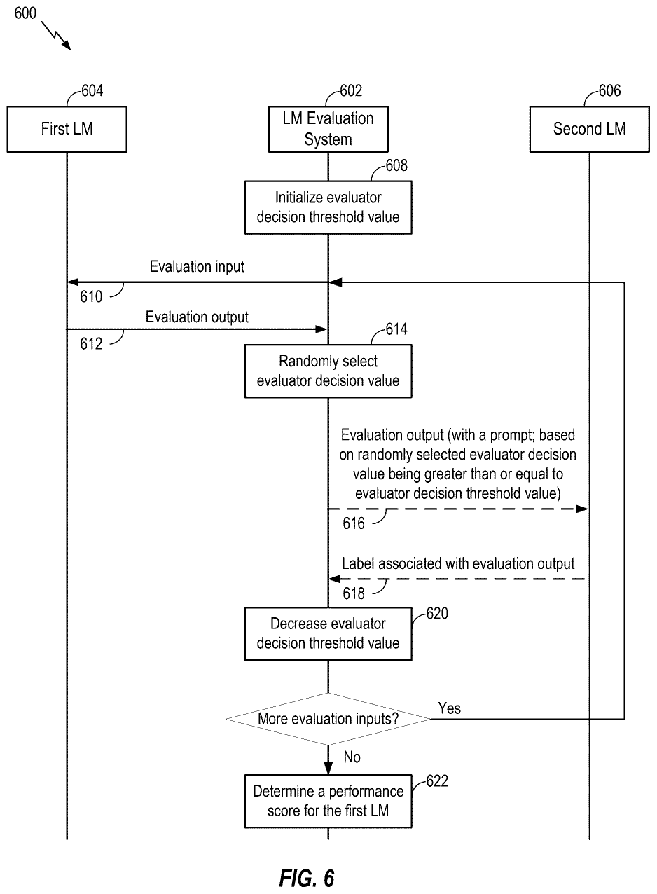

As described further herein with respect to FIG. 6, the system 100 (e.g., via the evaluator selector 128) provides the prompt 110 to the human evaluation system 112 or the second LM 114 based on a comparison of a randomly selected evaluator decision value against an evaluator decision threshold value (also referred to as “epsilon”). For example, the evaluator decision threshold value may be initialized to a particular value, such as 1. The evaluator selector 128 may select (e.g., randomly) the evaluator decision value from a defined range of evaluator decision values, such as 0 to 1. For example, the defined range of evaluator decision values may be from a first value at or higher than 0 to a second value at or less than the initialized evaluator decision threshold value. In certain aspects, the evaluator selector 128 may provide the prompt 110 (with the evaluation input 104 and the evaluation output 108) to the second LM 114 based on the randomly selected evaluator decision value being greater than or equal to the evaluator decision threshold value. In some aspects, the evaluator selector 128 may provide the prompt 110 (with the evaluation input 104 and the evaluation output 108) to the human evaluation system 112 based on the randomly selected evaluator decision value being less than the evaluator decision threshold value.

Accordingly, when the randomly selected evaluator decision value (e.g., selected from a range of [0,1]) may be at or substantially close to the initial evaluator decision threshold value (e.g., 1), there is a greater chance (e.g., when compared to when the evaluator decision threshold value has been decreased by a certain amount) that the randomly selected evaluator decision value would be less than the evaluator decision threshold value. Thus, at the outset, the LM evaluation may rely more on the human evaluation system 112 than on the second LM 114. As the evaluator decision threshold value is decreased to a lower value, such as a half-way point of the defined range of evaluator decision values (e.g., 0.5), there may be a lower chance than at the outset that the prompt 110 would be provided to the human evaluation system 112 for LM evaluation (e.g., about a 50% chance when the evaluator decision threshold value is decreased to around 0.5, a half-way point of a range of [0,1]).

As the evaluator decision threshold value is initialized to a particular value and then gradually decreased over iterations of LM evaluation, the system 100 initially relies more on the human evaluation system 112 (e.g., than the second LM 114) for LM evaluation. The greater dependence on the human evaluation system 112 at the outset allows the system 100 to acquire more of the correct evaluation outputs provided by the human evaluation system 112 (which is more likely to provide the correct evaluation outputs than the second LM 114, which may not be as likely to provide the correct evaluation outputs due to, for example, not having access to as much previously-acquired knowledge at the outset). For example, the randomly selected evaluator decision value (e.g., between 0 and 1) has a greater chance of being less than the evaluator decision threshold value at the outset (e.g., before the evaluator decision threshold value, such as initialized to 1, is decreased). As the evaluator decision threshold value is decreased from its initial value (e.g., from the initial value of 1 to 0.8, 0.7, 0.6, etc.), the randomly selected evaluator decision value selected from the whole of the defined range (e.g., between 0 and 1) has a lower chance of being less than the evaluator decision threshold value. Thus, as more evaluation outputs are acquired (and the evaluator decision threshold value is decreased further), the second LM 114 becomes more reliable to correctly evaluate the evaluation outputs. Accordingly, decreasing the evaluator decision threshold value allows the burden of evaluating of the outputs of the first LM 106 to be shifted increasingly more to the second LM 114, thereby alleviating the impracticality of performing an LM evaluation solely based on a human evaluator.

After the evaluation of the evaluation output 108 given the evaluation input 104, the human evaluation system 112 or the second LM 114 generates a label 116 associated with the evaluation output 108 (and the evaluation input 104). For example, the label 116 may indicate a binary response, such as whether the evaluation output 108 is correct or incorrect, true or false, or similar, given the evaluation input 104.

In some aspects, the steps of providing the evaluation input 104 to the first LM 106, receiving the evaluation output 108 from the first LM 106, providing the prompt 110 (with the evaluation input 104 and the evaluation output 108) to the human evaluation system 112 or the second LM 114, and receiving the label 116 from the human evaluation system 112 or the second LM 114 may be repeated for each and all of the plurality of evaluation inputs 102.

In certain aspects, after the first iteration of the steps described above, the system 100 may decrease the evaluator decision threshold value by a defined amount, and repeat the steps described above for a next evaluation input of the plurality of evaluation inputs 102 as the new evaluation input 104 for the subsequent iteration of the steps. The defined amount by which the evaluator decision threshold value is decreased is described further herein, for example, with respect to FIG. 6.

After all of the plurality of evaluation inputs 102 have been evaluated by the first LM 106 and a corresponding set of labels 116 have been generated via and received from the human evaluation system 112 or the second LM 114, a performance score generator 122 of the system 100 returns a performance score 124. The performance score generator 122 generates the performance score 124 based on the labels 116. For example, the performance score generator 122 may assign a numerical score for each binary response included in the labels 116 (e.g., “1” for a response of the evaluation output 108 being correct, true, or similar; and “0” for a response of the evaluation output 108 being incorrect, false, or similar), and determine a mathematical mean of the assigned numerical scores of the labels 116 as the performance score 124. The system 100 may provide a determination of whether the first LM 106 is ready for deployment based on the performance score 124. For example, if the performance score 124 satisfies (e.g., is greater than or equal to) a threshold performance score, the system may determine that the first LM 106 is ready for deployment. If the performance score does not satisfy (e.g., is less than) the threshold performance score, then the system may determine that the first LM 106 is not ready for deployment, which may in-turn prompt further training of first LM 106.

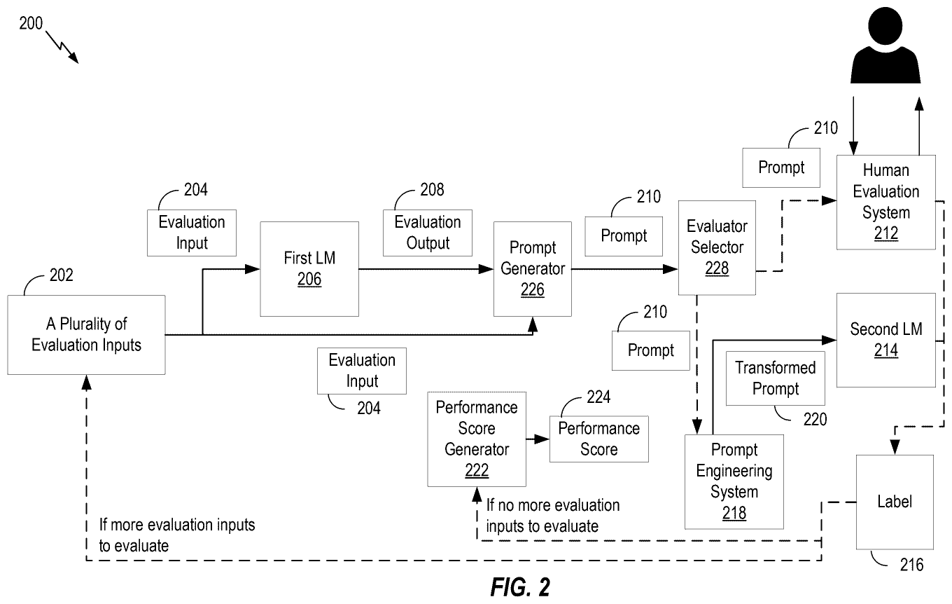

FIG. 2 depicts another example of a system 200 for evaluating an LM. The example of FIG. 2 depicts a plurality of evaluation inputs 202, an evaluation input 204, a first LM 206, an evaluation output 208, a prompt 210, a human evaluation system 212, a second LM 214, a label 216, a performance score generator 222, a performance score 224, a prompt generator 226, and an evaluator selector 228. These components of the example of FIG. 2 may be the same as or similar to, or may function in the same or similar manner as the corresponding components of the example of FIG. 1 (e.g., respectively, the plurality of evaluation inputs 102, the evaluation input 104, the first LM 106, the evaluation output 108, the prompt 110, the human evaluation system 112, the second LM 114, the label 116, the performance score generator 122, the performance score 124, the prompt generator 126, and the evaluator selector 128).

As similarly described with respect to the corresponding components or steps of FIG. 1, the system 200 initializes an evaluator decision threshold value, and the following steps are iteratively performed for the plurality of evaluation inputs 202 while the evaluator decision threshold value is decreased after each iteration: (1) the first LM 206 receives one of the plurality of evaluation inputs 202 (the evaluation input 204) and generates the evaluation output 208 based on the evaluation input 204, (2) the prompt generator 226 receives the evaluation input 204 and the evaluation output 208 and generates the prompt 210 based on the evaluation input 204 and the evaluation output 208, (3) the evaluator selector 228 receives the prompt 210 and makes a selection between evaluating the evaluation output 208 by the human evaluation system 212 and evaluating the evaluation output 208 by the second LM 214, and (4) the selected one of the human evaluation system 212 and the second LM 214 generates the label 216. After the above steps are completed for all of the plurality of evaluation inputs 202, the performance score generator 222 generates the performance score 224 based on the labels 216. Then, the system 200 may determine whether the first LM 206 is ready for deployment based on the performance score 224.

In certain aspects, the prompt 210 (before being provided to the second LM 214) is provided to a prompt engineering system 218. The prompt engineering system 218 generates and provides a transformed prompt 220 to the second LM 214. For example, the prompt engineering system 218 may generate the transformed prompt 220 based on a modified complexity level and/or a modified reasoning dimension. In some cases, an example of the prompt 210 may be to evaluate if the evaluation output 208 is considered correct given the evaluation input 204.

An example of the transformed prompt 220 based on a modified complexity level may be to evaluate if the evaluation output 208 is considered correct given the evaluation input 204, when the evaluation output 208 is considered in view of a target audience and/or a target industry. Thus, the second LM 214 would be instructed to evaluate not only whether information included in the evaluation output 208 is accurate, but also to evaluate whether the tone and/or the language of the evaluation output 208 is appropriate for a target audience and/or a target industry. For example, the prompt 210 may be “You need to evaluate if the evaluation output from the LM under evaluation is correct given the corresponding evaluation input.” An example of the transformed prompt 220 may be “You need to evaluate if the evaluation output from the LM under evaluation is correct given the corresponding evaluation input, while considering whether the tone and/or the language used in the evaluation output is appropriate for a target audience and/or a target industry in the financial sector.”

An example of the transformed prompt 220 based on a modified reasoning dimension may include an instruction to evaluate whether the evaluation output 208 is considered correct given the evaluation input 204, when the evaluation output 208 is considered in view of an example evaluation of another evaluation output. For example, the second LM 214 may be instructed to evaluate whether the evaluation output 208 is considered correct in view of an example evaluation of another evaluation output. In this scenario, the example evaluation of another evaluation output may be a previously performed evaluation. This example evaluation may indicate that another evaluation output was considered correct given another evaluation input. More specifically, the prompt 210 (before being transformed) may be “You need to evaluate whether the evaluation output from the LM under evaluation is correct given the corresponding evaluation input.” Then, a transformed version of the prompt 210 (the transformed prompt 220) may be “You need to evaluate whether the evaluation output from the LM under evaluation is correct given the corresponding evaluation input, while considering that the following evaluation output was considered correct given the following evaluation input: . . . .”

In the system 200 depicted in FIG. 2, the second LM 214 evaluates the evaluation output 208 based on the transformed prompt 220, where the evaluation based on the transformed prompt 220 may be more accurate than an evaluation of the evaluation output 208 based on the prompt 210 due to the additional information provided in the transformed prompt 220 (when compared to the prompt 210).

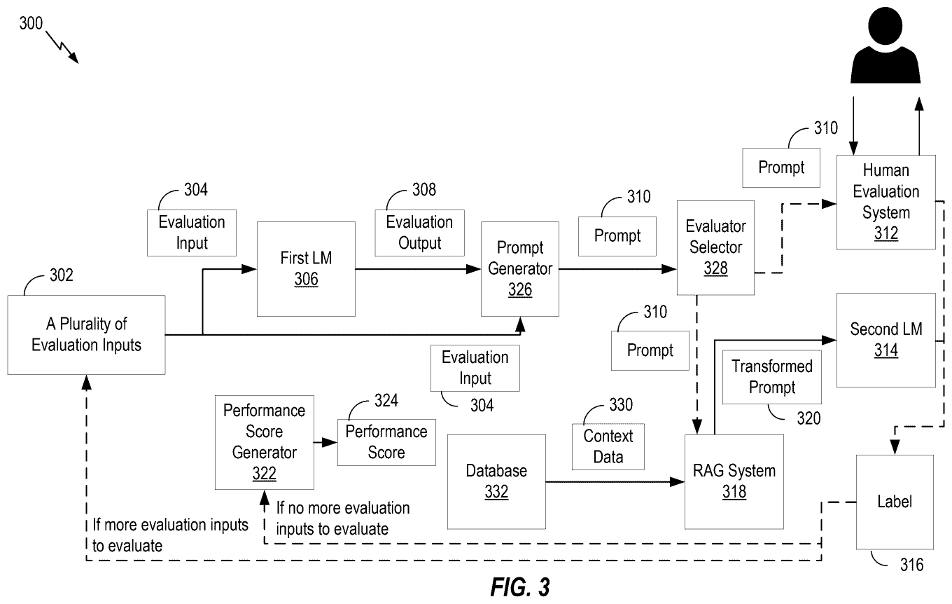

FIG. 3 depicts another example of a system 300 for evaluating an LM. The example of FIG. 3 depicts a plurality of evaluation inputs 302, an evaluation input 304, a first LM 306, an evaluation output 308, a prompt 310, a human evaluation system 312, a second LM 314, a label 316, a performance score generator 322, a performance score 324, a prompt generator 326, and an evaluator selector 328. These components of the example of FIG. 3 may be the same as or similar to, or may function in the same or similar manner as the corresponding components of the example of FIG. 1 (e.g., respectively, the plurality of evaluation inputs 102, the evaluation input 104, the first LM 106, the evaluation output 108, the prompt 110, the human evaluation system 112, the second LM 114, the label 116, the performance score generator 122, the performance score 124, the prompt generator 126, and the evaluator selector 128).

As similarly described with respect to the corresponding components or steps of FIG. 1, the system 300 initializes an evaluator decision threshold value, and the following steps are iteratively performed for the plurality of evaluation inputs 302 while the evaluator decision threshold value is decreased after each iteration: (1) the first LM 306 receives one of the plurality of evaluation inputs 302 (the evaluation input 304) and generates the evaluation output 308 based on the evaluation input 304, (2) the prompt generator 326 receives the evaluation input 304 and the evaluation output 308 and generates the prompt 310 based on the evaluation input 304 and the evaluation output 308, (3) the evaluator selector 328 receives the prompt 310 and makes a selection between evaluating the evaluation output 308 by the human evaluation system 312 and evaluating the evaluation output 308 by the second LM 314, and (4) the selected one of the human evaluation system 312 and the second LM 314 generates the label 316. After the above steps are completed for all of the plurality of evaluation inputs 302, the performance score generator 322 generates the performance score 324 based on the labels 316. Then, the system 300 may determine whether the first LM 306 is ready for deployment based on the performance score 324.

In the depicted example of FIG. 3, the system 300 includes and utilizes a retrieval-augmented generation (RAG) system 318. The RAG system 318 may improve an LM functionality by searching for relevant context information to provide to an LM alongside a prompt. For example, the RAG system 318 may search for and provide, to the second LM 314, context information that includes specific knowledge that is not encoded in the training data of the second LM 314. In some cases, a RAG-enhanced LM can expand a model's generative capabilities by configuring the model to access external datasets (e.g., context data 330) outside its original training data. These external datasets can include data related to, for example, domain-specific knowledge. Accordingly, the RAG system 318 may enable the second LM 314 to evaluate the evaluation output 308 given the evaluation input 304 based on the prompt 310 and additional context data retrieved, while still leveraging patterns learned from its original training data. In certain cases, a subset of the external datasets, such as the previously-acquired knowledge relating to previously evaluated evaluation inputs and evaluation outputs, may be used as a fine-tuning dataset for fine-tuning the second LM 314 for evaluating an LM.

To implement RAG, the context data 330 may be indexed and stored in a database 332 that allows for data retrieval. The context data 330 can be unstructured data such as unstructured text or structured data such as knowledge graphs. In some instances, the context data 330 may be encoded or vectorized. Accordingly, in response to receiving a user prompt (e.g., the prompt 310), a data retrieval component of the RAG system 318 works to select the most relevant data from the database 332. The most relevant data can be retrieved by using vector comparison techniques to identify the most relevant data to the prompt (e.g., the prompt 310). The retrieved data will be used to augment the original prompt (e.g., where the original prompt may be the prompt 310, and the augmented prompt may be a transformed prompt 320, including the context data 330 retrieved from the database 332), so that the model is able to generate an output based on the augmented prompt.

In certain aspects, the RAG system 318 may improve the accuracy and reliability of the second LM 314 by providing access to additional content from external data sources that contain more up-to-date data than the training data used to train the model, or that contain domain-specific data (as compared to training data which may be domain-independent). By utilizing the RAG system 318, the system 300 may provide a more accurate evaluation of the evaluation output 308 given the evaluation input 304 (and thus of the first LM 306).

For example, the evaluation may be based on a prompt that is more customized to a specific domain associated with the first LM 306. Additionally, the quality of the evaluation may be improved because the second LM 314 is able to retrieve content from vetted sources, meaning not only will the evaluation be more relevant to the prompt, but the evaluation will also be more accurate. For example, the data stored in the database 332 may include data corresponding to a previous evaluation of an evaluation output by a human evaluator (e.g., a domain expert). As the RAG system 318 is able to retrieve such previous evaluation data, the RAG system 318 can augment the prompt 310 based on the context data 330 that is relevant (e.g., most relevant) to the prompt 310 and corresponds to an evaluation by a domain expert. Accordingly, the system 300 (via the RAG system 318) can take advantage of the context data that includes an accurate evaluation, by a domain expert, of a similar evaluation output as the evaluation output being evaluated. Thus, the system 300 can improve its accuracy in evaluation of evaluation outputs while alleviating the burden and the impracticality of evaluating each evaluation output by a human evaluator. Beneficially, RAG allows a system to leverage the capabilities of an LM without having to perform fine-tuning on the LM. By avoiding the need for additional training, RAG-enabled LMs do not require the extensive computational resources associated with fine-tuning.

The RAG system 318 generates and provides the transformed prompt 320 to the second LM 314. For example, the RAG system 318 may generate the transformed prompt 320 based on the context data 330 retrieved from the database 332. In some cases, an example of the prompt 310 may include an instruction to evaluate whether the evaluation output 308 is considered correct given the evaluation input 304. An example of the transformed prompt 320 provided by the RAG system 318 may include an instruction to evaluate whether the evaluation output 308 is considered correct given the evaluation input 304, when the evaluation output 308 is considered in view of the context data 330 retrieved from the database 332. Thus, the second LM 314 would be instructed to evaluate whether information included in the evaluation output 308 is accurate, given not only the evaluation input 304 but also the context data 330 which, for example, may be related to a previous evaluation of a similar evaluation input that is similar to the evaluation input 304. Other types of context data 330 may also be possible, such as the dynamic knowledge and/or the domain-specific knowledge related to the evaluation input 304. More specifically, an example of the prompt 310 may be “You need to evaluate if the evaluation output of ‘Contribute to Retirement Accounts’ from the LM under evaluation is correct given the corresponding evaluation input of ‘How can I reduce my taxable income?’” An example of the transformed prompt 320 related to the above example of the prompt 310 may be “You need to evaluate if the evaluation output of ‘Contribute to Retirement Accounts’ from the LM under evaluation is correct given the corresponding evaluation input of ‘How can I reduce my taxable income?’, while considering that an evaluation output of ‘Contribute to Retirement Accounts’ given an evaluation input of ‘Is it possible to reduce my taxable income?’ was considered not correct for not being complete.”

As described above, the system 300 (via the RAG system 318) can take advantage of context data that can improve the system's accuracy in evaluation of evaluation outputs while alleviating the burden and the impracticality of evaluating each evaluation output by a human evaluator.

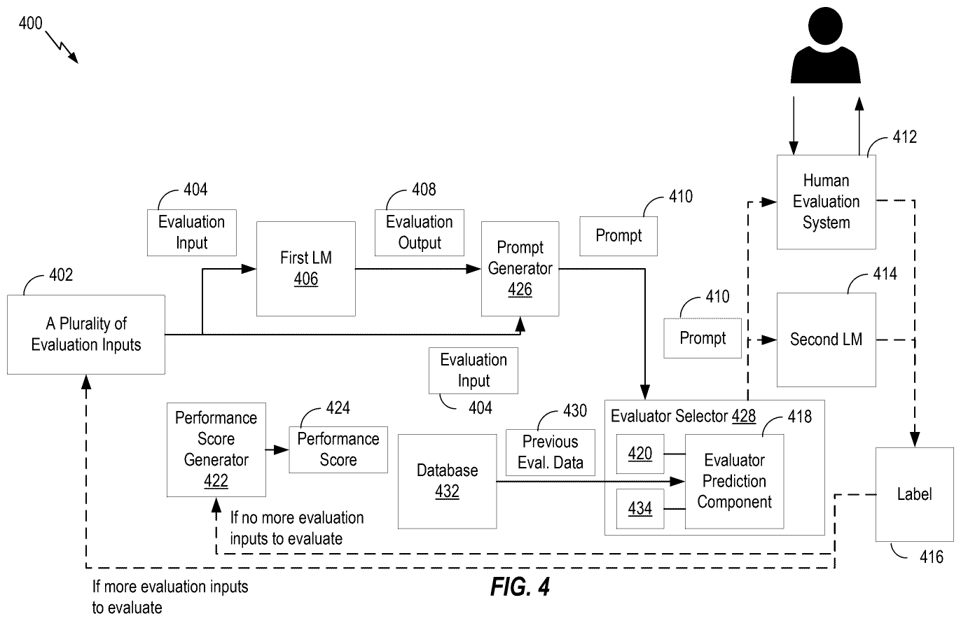

FIG. 4 depicts another example of a system 400 for evaluating an LM. The example of FIG. 4 depicts a plurality of evaluation inputs 402, an evaluation input 404, a first LM 406, an evaluation output 408, a prompt 410, a human evaluation system 412, a second LM 414, a label 416, a performance score generator 422, and a performance score 424. These components of the example of FIG. 4 may be the same as or similar to, or may function in the same or similar manner as the corresponding components of the example of FIG. 1 (e.g., respectively, the plurality of evaluation inputs 102, the evaluation input 104, the first LM 106, the evaluation output 108, the prompt 110, the human evaluation system 112, the second LM 114, the label 116, the performance score generator 122, and the performance score 124).

As similarly described with respect to the corresponding components or steps of FIG. 1, the system 400 initializes an evaluator decision threshold value, and the following steps are iteratively performed for the plurality of evaluation inputs 402 while the evaluator decision threshold value is decreased after each iteration: (1) the first LM 406 receives one of the plurality of evaluation inputs 402 (the evaluation input 404) and generates the evaluation output 408 based on the evaluation input 404, (2) the prompt generator 426 receives the evaluation input 404 and the evaluation output 408 and generates the prompt 410 based on the evaluation input 404 and the evaluation output 408, (3) the evaluator selector 428 receives the prompt 410 and makes a selection between evaluating the evaluation output 408 by the human evaluation system 412 and evaluating the evaluation output 408 by the second LM 414, and (4) the selected one of the human evaluation system 412 and the second LM 414 generates the label 416. After the above steps are completed for all of the plurality of evaluation inputs 402, the performance score generator 422 generates the performance score 424 based on the labels 416. Then, the system 400 may determine whether the first LM 406 is ready for deployment based on the performance score 424.

In the depicted example of FIG. 4, the prompt 410 (before being provided to the human evaluation system 412 or the second LM 414) is provided to an evaluator prediction component 418. The evaluator prediction component 418 is configured to generate a prediction relating to whether the prompt 410 should be provided to the human evaluation system 412 or the second LM 414. For example, the evaluator prediction component 418 may predict whether the second LM 414 will accurately evaluate the evaluation output 408 given the evaluation input 404. If the evaluator prediction component 418 predicts that the second LM 414 will perform an accurate evaluation, the evaluator prediction component 418 causes the evaluator selector 428 to provide the prompt 410 to the second LM 414 to evaluate the evaluation output 408 given the evaluation input 404. Otherwise, the evaluator prediction component 418 causes the evaluator selector 428 to provide the prompt 410 to the human evaluation system 412.

In certain aspects, the evaluator prediction component 418 may identify and retrieve an instance of previous evaluation data 430 (e.g., from a database 432) that includes a previously evaluated evaluation input and a previously evaluated evaluation output. In some cases, this previous evaluation data 430 may include a previously evaluated evaluation input that is the most similar to the evaluation input 404. For example, the most similar evaluation input may be identified based on a vector comparison between a first embedding associated with the evaluation input 404 and a second embedding associated with an instance of the previous evaluation data 430. Such vector comparison may be performed by the evaluator prediction component 418. In some cases, the evaluator prediction component 418 may generate the first embedding associated with the evaluation input 404 at run time, while the second embedding (e.g., associated with an instance of the previous evaluation data 430) may be stored in the database 432. For example, the second embedding may be generated prior to being stored in the database 432. In some cases, the second embedding may be generated at run time (e.g., by another model or system configured to generate embeddings), where the other model or system (e.g., embedding generator 420) may generate the first embedding, too, at run time. For example, the evaluator prediction component 418 may include or may be in data communication with the other model or system, such as the embedding generator 420 depicted in FIG. 4, configured to generate the embeddings.

In certain aspects, the evaluation input 404 is matched to the most similar (e.g., comparable) evaluation input satisfying a defined threshold level of similarity. In one example, syntactic similarity may be used to match the evaluation input 404 to the most similar evaluation input, where syntactic similarity refers to the degree to which two sentences, phrases, or textual structures share a similar syntactic structure, regardless of their semantic meaning. Syntactic similarity may be measured by comparing the arrangement of words, phrases, and grammatical components within sentences. For example, the syntactic similarity may be related to a grammatical composition of a text, rather than a meaning of the text (e.g., a word order, grammatical roles, etc.). The syntactic similarity may be measured based on a parsing-based analysis, using techniques such as dependency parsing or constituency parsing to evaluate similarity. For example, “A followed B” may have a high syntactic similarity with “B was followed by A” based on the similarity in structure (where the latter is a passive voice version of the former). As another example, “A followed B” may have a low syntactic similarity with “B ran away from A” based on the difference in structure. Some examples of measurement techniques for syntactic similarity include tree edit distance technique, which compares syntactic parse trees (graphical representations of the grammatical structures of sentences, each showing how words are grouped into phrases and how those phrases relate to each other within the sentence hierarchy); cosine similarity on dependency trees technique, which measures similarity using vectorized dependency relationships; and Jaccard similarity on part-of-speech (POS) tags technique, which compares POS tag sequences (sequences of labels assigned to words in a sentence to indicate their grammatical category).

Based on whether the defined threshold level of syntactic similarity is satisfied, the evaluator prediction component 418 may cause the evaluator selector 428 to provide the prompt 410 to the second LM 414 to evaluate the evaluation output 408. For example, if the defined threshold level of syntactic similarity is satisfied, the evaluator prediction component 418 may cause the evaluator selector 428 to provide the prompt 410 to the second LM 414. When the defined threshold level of syntactic similarity is satisfied between a previously evaluated (e.g., labeled) evaluation input (of the previous evaluation data 430) and the evaluation input 404, this means that an evaluation input that is sufficiently similar to the evaluation input 404 has previously been evaluated. In some cases, the previous evaluation data 430 can then be used by the second LM 414 for certain techniques, such as described with respect to FIG. 2 (prompt engineering, where the previous evaluation data 430 can be added as part of a transformed prompt 220) or FIG. 3 (RAG, where the previous evaluation data 430 can be used as context data 330). Accordingly, the evaluator prediction component 418 may predict that the second LM 414 will accurately evaluate the evaluation output 408 given the evaluation input 404, for example, by using the previous evaluation data 430 for one or more of the techniques described above.

If the defined threshold level of syntactic similarity is not satisfied, the evaluator prediction component 418 may cause the evaluator selector 428 to provide the prompt 410 to the human evaluation system 412 to evaluate the evaluation output 408 with the evaluation input 404. For example, if the evaluator prediction component 418 does not find, from the database 432, an instance of the previous evaluation data 430 that satisfies the defined threshold level of syntactic similarity, this means that none of the previously evaluated evaluation inputs are sufficiently similar to the evaluation input 404. Thus, the previous evaluation data 430 would be sufficiently different from the evaluation input 404, such that the techniques described herein with respect to FIG. 2 or 3 could not be performed effectively (e.g., the previous evaluation data 430 would not provide a good example to augment a prompt, or serve as good context data for RAG). Accordingly, it may not be as likely that the second LM 414 can accurately evaluate the evaluation output 408 given the evaluation input 404. The evaluator prediction component 418 may cause the evaluator selector 428 to send the prompt 410 to the human evaluation system 412, such that the evaluation output 408 given the evaluation input 404 may be accurately evaluated (e.g., by a domain expert), and the data relating to the evaluation by the human evaluation system 412 may be added to the database 432. Such data relating to the evaluation by the human evaluation system 412 may be used during a subsequent evaluation (e.g., by the second LM 414) when, for example, the subsequent evaluation input is sufficiently similar to the evaluation data that was added to the database 432.

In some aspects, the defined threshold level of syntactic similarity may be optimized using an optimization algorithm. For example, an optimizer 434 may determine the appropriate level of syntactic similarity to use as a threshold for determining whether an instance of the previous evaluation data 430 can be used by the second LM 414 to evaluate the evaluation output 408 given the evaluation input 404. In some cases, an edit distance between the instance of the previous evaluation data 430 and the evaluation input 404 may be used for a determination of syntactic similarity. The edit distance refers to a way of quantifying how similar or dissimilar two strings (e.g., words) are to each another. The edit distance may be measured by counting the minimum number of operations required to transform one string into the other. Examples of the operations include insertion, deletion, substitution, and transposition. Depending on the allowed operation(s), the edit distance may be determined based on different edit distance algorithms, such as Levenshtein Distance, Longest Common Subsequence (LCS), Hamming Distance, Damerau-Levenshtein Distance, and Jaro Distance. The optimizer 434 may determine which number of allowed operations and/or which type of edit distance algorithm results in improvement in the performance of the evaluator prediction component 418 (e.g., in correctly predicting whether the second LM 414 will accurately evaluate the evaluation input 404). Accordingly, the optimizer 434 may determine, for example, which subset of allowed operations and/or which edit distance algorithm to use for determining an edit distance between an instance of the previous evaluation data 430 and the evaluation input 404, to improve the performance of the evaluator prediction component 418.

In some aspects, the evaluator prediction component 418 may be or include an LM (e.g., a third LM) trained based on a training dataset that includes a plurality of evaluation inputs and evaluation outputs that are evaluated by both a human (e.g., via the human evaluation system 412) and the second LM 414. For example, the human evaluation system 412 and the second LM 414 may be used to generate the training dataset which can be used to train the third LM (e.g., of the evaluator prediction component 418) to predict which type or pattern of evaluation input and evaluation output may result in an accurate evaluation by the second LM 414. An example of such LM may be a binary text classifier model that learns, based on the training dataset described above, which instances of the training dataset were accurately evaluated by the second LM 414 (e.g., where the evaluation by the second LM 414 agrees with the evaluation by the human evaluation system 412). Thus, the third LM may be fine-tuned as a binary text classifier model to predict whether or not an evaluation input may be accurately evaluated by the second LM 414. Accordingly, the third LM may receive, as an input, an instance of evaluation input and provide, as an output, a prediction of whether or not the received instance of evaluation input may be accurately evaluated by the second LM 414. If the third LM predicts that the received instance of evaluation input will be accurately evaluated by the second LM 414, the evaluator prediction component 418 may cause the evaluator selector 428 to select the second LM 414 for LM evaluation.

### Example Prompts to Second Large Language Model for Evaluating First Large Language Model

FIG. 5A depicts an example prompt 510a for evaluating an LM. The example prompt 510a depicted in FIG. 5A may correspond to (e.g., may be an example of) the prompt 110, 210, 310, 410 depicted and described herein with respect to, respectively, FIG. 1, FIG. 2, FIG. 3, and FIG. 4.

As depicted, an example evaluation input 504a includes “How can I reduce my taxable income?” First LM 506a (corresponding to, for example, the first LM 106, 206, 306, 406 of, respectively, FIG. 1, FIG. 2, FIG. 3, and FIG. 4) receives the example evaluation input 504a and generates an example evaluation output 508a based on the example evaluation input 504a. Here, the example evaluation output 508a includes “Reducing your taxable income can be achieved through a variety of strategies. For example, contribute to Pre-Tax Retirement Accounts.” A prompt generator 526a (corresponding to the prompt generator 126, 226, 326, 426 of, respectively, FIG. 1, FIG. 2, FIG. 3, and FIG. 4) receives the example evaluation input 504a and the example evaluation output 508a, and generates the example prompt 510a which, in the depicted example of FIG. 5A, includes “You need to evaluate if the given answer of ‘Reducing your taxable income can be achieved through a variety of strategies. For example, contribute to Pre-Tax Retirement Accounts.’ is considered correct for the current question of ‘How can I reduce my taxable income?’” The example prompt 510a includes an instruction to evaluate the example evaluation output 508a given the example evaluation input 504a, such as to evaluate the first LM 506a.

FIG. 5B depicts an example transformed prompt 520 for evaluating an LM. In the depicted example of FIG. 5B, an example evaluation input 504b, first LM 506b, an example evaluation output 508b, a prompt generator 526b, and an example prompt 510b may be the same as or correspond to, respectively, the example evaluation input 504a, the first LM 506a, the example evaluation output 508a, the prompt generator 526a, and the example prompt 510a of FIG. 5A.

As depicted, a RAG system 518 (corresponding to the RAG system 318 of FIG. 3) receives the example prompt 510b and generates the example transformed prompt 520. The example transformed prompt 520 may be an example of the transformed prompt 320 of FIG. 3, where the following portion of the example transformed prompt 520 may be context data: “Here is an example. Given the question of ‘How can I reduce my taxable income?’ and the answer of ‘Reducing your taxable income can be achieved through a variety of strategies. For example, contribute to Pre-Tax Retirement Accounts’, the correct evaluation is ‘False’ because this answer is very partial and should contain more information about Health Savings Accounts, Flexible Spending Accounts, etc.” This context data may be an example of the context data 330 described as being retrieved from the database 332 of FIG. 3. In some cases, such context data may be retrieved from a database (e.g., the database of FIG. 3), which includes previously evaluated evaluation inputs and evaluation outputs. For example, “Is it possible to reduce my taxable income?” may be a previously evaluated evaluation input, and “Reducing your taxable income can be achieved through a variety of strategies. For example, contribute to Pre-Tax Retirement Accounts” may be a previously evaluated evaluation output. In some cases, based on the example evaluation input 504b of “How can I reduce my taxable income?” being different than the previously evaluated evaluation input of “Is it possible to reduce my taxable income” by three words (e.g., “How can I”), the RAG system 518 may determine that an example threshold level of syntactic similarity (e.g., of being different by four words or less) is achieved. Based on this determination, the RAG system 518 may determine that the example evaluation input 504b and the example evaluation output 508b are to be evaluated by a second LM (e.g., the second LM 314 of FIG. 3), and provide the example transformed prompt 520 to the second LM.

In some aspects, the example transformed prompt 520 of FIG. 5B may correspond to the transformed prompt 220 depicted and described herein with respect to FIG. 2. In such example, the example transformed prompt 520 may be generated by a prompt engineering system (e.g., the prompt engineering system 218 of FIG. 2).

### Example Process Flow for Evaluating a Large Language Model

FIG. 6 depicts a process flow 600 for communications between an LM evaluation system 602, a first LM 604, and a second LM 606. In some aspects, the LM evaluation system 602 may be an example of the systems 100, 200, 300, 400 depicted and described with respect to, respectively, FIG. 1, FIG. 2, FIG. 3, and FIG. 4. The first LM 604 may be an example of the first LM 106, 206, 306, 406 depicted and described with respect to, respectively, FIG. 1, FIG. 2, FIG. 3 and FIG. 4. Moreover, the second LM 606 may be an example of the second LM 114, 214, 314, 414 depicted and described with respect to, respectively, FIG. 1, FIG. 2, FIG. 3, and FIG. 4. Note that any operations illustrated with dashed lines may indicate that that operation is an optional or alternative example, unless noted otherwise.

At 608, the LM evaluation system 602 initializes an evaluator decision threshold value by setting an initial value of the evaluator decision threshold value. The evaluator decision threshold value may correspond to the evaluator decision threshold value described herein with respect to, for example, FIG. 1. In certain cases, the initialized evaluator decision threshold value may be a value of a defined range of possible values, such as 0.5, 1, or the like for a range of [0,1]. As described herein, a randomly selected evaluator decision value (e.g., from step 614 described below) that is higher than an evaluator decision threshold value results in an LM evaluation by the second LM 606, and the selected evaluator decision value that is lower than the evaluator decision threshold value results in an LM evaluation by a human. Thus, a lower initial evaluator decision threshold value means that the second LM 606 will be chosen more often for the LM evaluation, which in-turn reduces the reliance on a human. A higher initial evaluator decision threshold value means that the human will be chosen more often for the LM evaluation (e.g., at the outset). In certain cases, at the outset of the steps described with respect to FIG. 6, the evaluator decision threshold value may be relatively high (e.g., 1), and the randomly selected evaluator decision value (e.g., 0.5) may be less than the evaluator decision threshold value. Accordingly, at the outset of the steps, the LM evaluation system 602 may likely (e.g., more likely than after certain iterations of the steps having been performed) provide the prompt to a human evaluation system (e.g., the human evaluation system 112, 212, 312, 412 of, respectively, FIG. 1, FIG. 2, FIG. 3, and FIG. 4.) to evaluate the evaluation input and the evaluation output. Having more opportunities for a human to evaluate the LM at the outset of the evaluation may allow a number of evaluation outputs to be provided by a human, such that these evaluation outputs can be relied upon to maintain the same or similar level of accuracy of the evaluation even as the burden of the evaluation is shifted to the second LM 608. For example, the evaluation outputs provided by the human may be used for the techniques, such as prompt engineering and RAG techniques, as described herein with respect to FIGS. 2 and 3.

At 610, the LM evaluation system 602 provides an evaluation input of a plurality of evaluation inputs to the first LM 604. Examples of evaluation inputs for a tax domain include: “What are some common tax deductions and credits I might be eligible for?”, “How can I reduce my taxable income?”, “What is the deadline for filing my income tax return?”, “What documents do I need to prepare my tax return?”, “How do I file for a tax extension if I need more time?”, “What are the tax implications of selling my home?”, “How are my investments (stocks, bonds, mutual funds) taxed?”, “What is the difference between a tax credit and a tax deduction?”, “How can I estimate my tax refund?”, “What should I do if I receive an audit notice from the IRS?”, and “How can I calculate the amount of tax refund I might receive?”

At 612, the first LM 604 provides an evaluation output to the LM evaluation system 602. For example, the evaluation output may be associated with the evaluation input of step 610 based on the evaluation output being generated by the first LM 604 based on the evaluation input.

At 614, the LM evaluation system 602 randomly selects an evaluator decision value. For example, the LM evaluation system 602 may randomly select the evaluator decision value from a defined range of values, such as 0 to 1. As one example, the LM evaluation system 602 may randomly select 0.5.

At 616, the LM evaluation system 602 optionally provides the evaluation output, with a prompt, to the second LM 606. For example, the LM evaluation system 602 provides the evaluation output, with the prompt, to the second LM 606 based on the randomly selected evaluator decision value being greater than or equal to the evaluator decision threshold value. This means as the evaluator decision threshold value is decreased (e.g., after each iteration of the steps 610-620), the LM evaluation system 602 will provide the evaluation output, with the prompt, to the second LM 606 increasingly more often. If the randomly selected evaluator decision value is less than the evaluator decision threshold value, the LM evaluation system 602 provides the evaluation output, with the prompt, to a human evaluation system. This means that the LM evaluation system 602 will provide the evaluation output, with the prompt, to a human evaluation system more often at the outset of the process flow 600 (e.g., when the evaluator decision threshold value has not been decreased as much). In some cases, when the randomly selected evaluator decision value is greater than or equal to the evaluator decision threshold value, the second LM may be selected between a human (e.g., a human evaluation system) and the second LM based on a random selection for providing the evaluation output to. This may enable an improved accuracy for evaluating the LM. For example, when the second LM is selected between the human and the second LM based on a random selection, the process flow 600 may allow additional iterations of the flow to include evaluation of the first LM by a human evaluation system (e.g., at the outset of flow). The evaluation data based on the evaluation of the first LM by the human evaluation system may be relied upon for subsequent or future evaluation of other LMs, where the human evaluation system may be relied upon less due to the availability of the evaluation data that the second LM can use to augment its evaluation accuracy.

At 618, the second LM 606 optionally provides a label associated with the evaluation output to the LM evaluation system 602. For example, the second LM 606 provides the label to the LM evaluation system 602 based on receiving the evaluation output from the LM evaluation system 602 at 616. If the LM evaluation system 602 does not provide the evaluation output to the second LM 606 at 616 (e.g., if the LM evaluation system 602 provides the evaluation output to a human evaluation system), the second LM 606 does not provide the label to the LM evaluation system 602 at 618. Instead, the human evaluation system may provide the label to the LM evaluation system 602 based on the LM evaluation system 602 providing the evaluation output to the human evaluation system. This means that the burden of generating and providing the label (e.g., based on evaluating the evaluation output of the first LM 604) shifts increasingly more to the second LM 606 as the iterations of the steps progress and the evaluator decision threshold value is decreased after each iteration. In certain cases, the label associated with the evaluation output may include an indication of whether the evaluation output is correct given the evaluation input, as described herein with respect to, for example, FIG. 1.

At 620, the LM evaluation system 602 decreases the evaluator decision threshold value. In certain aspects, the LM evaluation system 602 may decrease the evaluator decision threshold value based on a linear decay scheme, an exponential decay scheme, or an inverse schedule (e.g., using a hyperbolic decay scheme). For the linear decay scheme, the evaluator decision threshold value may be decreased by a fixed amount for each iteration of the steps 610-620. This scheme results in a steady and predictable decrease in exploratory actions of using the human evaluation system or the second LM 606 for LM evaluation. For example, the evaluator decision threshold value may start at 1 and decrease by 0.01 after each iteration. For the exponential decay scheme, the evaluator decision threshold value may be decreased based on a fixed percentage for each iteration of the steps 610-620. For example, the evaluator decision threshold value may start at 1, and the evaluator decision threshold value may be multiplied by 0.99 to provide a new evaluator decision threshold value, where the evaluator decision threshold value may decrease quickly at the outset but gradually slow down in the decrease, allowing some level of exploration (of using the human evaluation system or the second LM 606) throughout the iterations of steps 610-620. For the inverse schedule (e.g., using the hyperbolic decay scheme), the evaluator decision threshold value may start at an initial value and gradually decrease according to a schedule where the evaluator decision threshold value decreases more slowly as time progresses. Thus, the exploration of using the human evaluation system or the second LM 606 is retained to an extent at the outset, and the process flow 600 may gradually focus more on exploiting using the second LM 606 over time.

In some aspects, the LM evaluation system 602 may decrease the evaluator decision threshold value by a defined amount based on an accuracy of an evaluator prediction component (e.g. the evaluator prediction component 418 of FIG. 4). For example, if the evaluator prediction component 418 has been optimized and determined to have increased in accuracy in predicting a better evaluator (e.g., in predicting the second LM 606 as the better evaluator) by a certain extent (e.g., a certain percentage) when compared to the performance before the optimization, the LM evaluation system 602 may decrease the evaluator decision threshold value by the same extent (e.g., the same percentage) after each iteration of the steps 610-618 of FIG. 6. For example, the evaluator prediction component 418 may be optimized in accordance with the optimization relating to an edit distance algorithm described above with respect to FIG. 4 or its LM—a third LM—may be fine-tuned prior to the steps of FIG. 6. In one example, if the LM evaluation system 602 was decreasing the evaluator decision threshold value by D after each iteration before the evaluator prediction component 418 is optimized with 10% increase in performance (e.g., correctly predicting the second LM 606 to accurately evaluate an evaluation input 10% more of the times), the LM evaluation system 602 would decrease the evaluator decision threshold value by (1.10×D) after each iteration after the evaluator prediction component 418 has been optimized.

As the iterations of the steps progress, the evaluator decision threshold value is decreased after each iteration. Thus, the LM evaluation system 602 may likely (e.g., more likely than at the outset of the steps) provide the prompt to the second LM 606 to evaluate the evaluation input and the evaluation output. Accordingly, reliance on human for evaluating the first LM 604 is reduced as the iterations of the steps of FIG. 6 progress, thereby increasingly alleviating the impracticality of relying (e.g., solely) on a human to evaluate the first LM 604.

As depicted, steps 610-620 are repeated for each evaluation input of the plurality of evaluation inputs.

At 622, the LM evaluation system 602 determines a performance score for the first LM. For example, the LM evaluation system 602 may calculate a mean of scores based on the labels received from the second LM 606 for the plurality of evaluation inputs and the plurality of associated evaluation outputs (e.g., 1 for an indication of correct response, and 0 for an indication of false or not-correct response).

In certain aspects, the LM evaluation system 602 may, based on the performance score for the first LM 604 being greater than or equal to a threshold performance score (e.g., 0.8 or the like), determine that the first LM 604 is approved for a defined use case. Examples of uses cases may include an application for rewriting a subject line of an email, an application for tax return, a chatbot, an application where a bank transaction may be matched to an invoice entry, content moderation of text, an application for writing an employee performance review, etc. When the first LM 604 is approved for the defined use case, the first LM 604 may receive inputs (e.g., production inputs related to the defined use case, such as from a user) and generate outputs based on the received inputs. For example, based on the performance score for the first LM 604 being greater than or equal to the threshold performance score, one or more production inputs may be (e.g., automatically) directed to the first LM 604.

### Example Method for Evaluating a Large Language Model

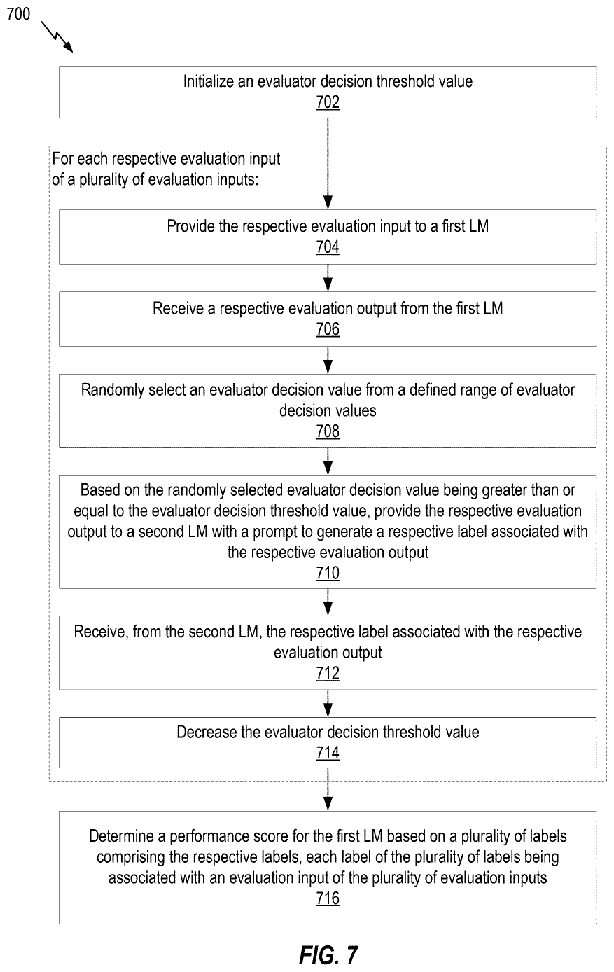

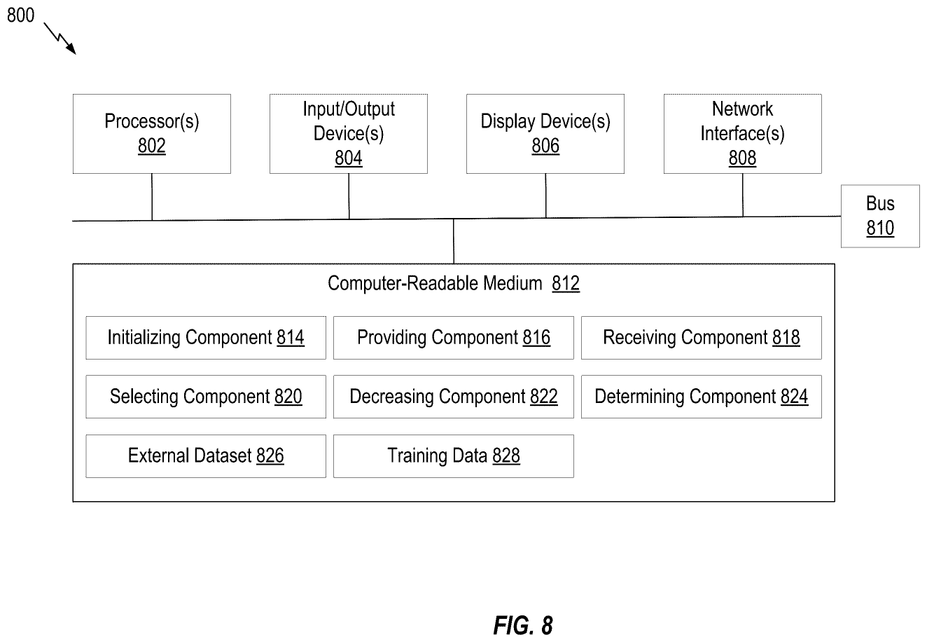

FIG. 7 depicts an example method 700 for evaluating an LM. In one aspect, method 700 can be implemented by the systems 100, 200, 300, 400 of, respectively, FIG. 1, FIG. 2, FIG. 3 and FIG. 4, the LM evaluation system 602 of FIG. 6, and/or processing system 800 of FIG. 8.

Method 700 starts at block 702 with initializing an evaluator decision threshold value. For example, the evaluator decision threshold value may correspond to the evaluator decision threshold value described with respect to FIG. 1.

For each respective evaluation input of a plurality of evaluation inputs, blocks 704-714 are repeated.

Method 700 continues to block 704 with providing the respective evaluation input to a first LM. For example the first LM may correspond to the first LM 106, 206, 306, 406 of, respectively, FIG. 1, FIG. 2, FIG. 3, and FIG. 4.

Method 700 continues to block 706 with receiving a respective evaluation output from the first LM.

Method 700 continues to block 708 with randomly selecting an evaluator decision value from a defined range of evaluator decision values. For example, the randomly selected evaluator decision value and the defined range of evaluator decision values may correspond to the randomly selected evaluator decision value and the defined range of evaluator decision values described herein with respect to FIG. 6.

Method 700 continues to block 710 with, based on the randomly selected evaluator decision value being greater than or equal to the evaluator decision threshold value, providing the respective evaluation output to a second LM with a prompt to generate a respective label associated with the respective evaluation output.

In certain aspects, providing the respective evaluation output to the second LM with the prompt includes, for at least one respective evaluation input of the plurality of evaluation inputs: generating a transformed prompt based on at least one of a modified complexity level or a modified reasoning dimension; and providing the transformed prompt to the second LM. In some cases, these methods may be performed by use of a prompt engineering system, such as the prompt engineering system 218 described herein with respect to FIG. 2.

In certain aspects, providing the respective evaluation output to the second LM with the prompt includes, for at least one respective evaluation input of the plurality of evaluation inputs: determining at least one previously labeled evaluation input as being a comparable evaluation input comparable to the at least one respective evaluation input; retrieving a label associated with the comparable evaluation input; generating a transformed prompt based on the retrieved label; and providing the transformed prompt to the second LM. In some cases, these methods may be performed by use of a RAG system, such as the RAG system 318 described herein with respect to FIG. 3.

In certain aspects, providing the respective evaluation output to the second LM is further based on predicting, using an evaluator prediction component, that the second LM will generate an accurate label for the respective evaluation input. For example, the evaluator prediction component may correspond to the evaluator prediction component 418 described herein with respect to FIG. 4.

In some cases, predicting, using the evaluator prediction component, that the second LM will generate an accurate label for the respective evaluation input includes: identifying a previously labeled evaluation input that is closest to the respective evaluation input based on a syntactic similarity level between the previously labeled evaluation input and the respective evaluation input; and based on the syntactic similarity level being greater than or equal to a threshold syntactic similarity level, predicting that the second LM will generate an accurate label for the respective evaluation input.

In some cases, using the evaluator prediction component includes using a third LM that is trained to predict whether the second LM will generate an accurate label for an evaluation input.

In some cases, decreasing the evaluator decision threshold value includes decreasing the evaluator decision threshold value by a defined amount based on an accuracy of the evaluator prediction component.

In certain aspects, the second LM is selected between a human and the second LM based on a random selection for providing the respective evaluation output to for block 710.

Method 700 continues to block 712 with receiving, from the second LM, the respective label associated with the respective evaluation output. In certain aspects, the respective label may include the respective evaluation input, the respective evaluation output, and an indication of whether the respective evaluation output is considered correct given the respective evaluation input.

Method 700 continues to block 714 with decreasing the evaluator decision threshold value. In certain aspects, decreasing the evaluator decision threshold value at block 714 may correspond to the decreasing of the evaluator decision threshold value described herein with respect to 620 of FIG. 6.

Method 700 continues to block 716 with determining a performance score for the first LM based on a plurality of labels comprising the respective labels, each label of the plurality of labels being associated with an evaluation input of the plurality of evaluation inputs.

In certain aspects, determining the performance score for the first LM includes calculating a mean of a plurality of Boolean values associated with a plurality of evaluation outputs for the plurality of evaluation inputs.

In certain aspects, method 700 further includes, based on the performance score for the first LM being greater than or equal to a threshold performance score, determining that the first LM is approved for a defined use case.

Method 700 for evaluating an LM may alleviate the impracticality of evaluating an LM (e.g., solely) by a human, such as based on a reduced reliance on evaluating the LM by the human. Additionally, in certain aspects, method 700 may enable an improved accuracy when evaluating an LM whose use case spans multiple domains by using the techniques described herein with respect to, for example, FIGS. 2-3. In some cases, method 700 may use a RAG system that provides access to various domains of evaluation samples. For example, the RAG system may provide access to domain-specific knowledge of various domains (e.g., finance, tax, law, etc.) as well as previously-labeled evaluation inputs that span multiple domains.

Note that FIG. 7 is just one example of a method, and other methods including fewer, additional, or alternative operations are possible consistent with this disclosure.

### Example Processing System for Evaluating a Large Language Model

FIG. 8 depicts an example processing system 800 configured to perform various aspects described herein, including, for example, method 700 as described above with respect to FIG. 7.

Processing system 800 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, display device(s) 806, network interface(s) 808, and/or computer-readable medium 812. In certain aspects, processor(s) 802 are representative of one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various aspects, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

Computer-readable medium 812 may be a volatile memory, such as a random access memory (RAM), or a nonvolatile memory, such as nonvolatile random access memory (NVRAM), or the like. In this example, computer-readable medium 812 includes initializing component 814, providing component 816, receiving component 818, selecting component 820, decreasing component 822, determining component 824, external dataset 826, and training data 828.

In certain aspects, initializing component 814 is configured to initialize an evaluator decision threshold value, such as performed for block 702 of FIG. 7.

In certain aspects, providing component 816 is configured to provide a respective evaluation input to a first LM, such as performed for block 704 of FIG. 7. In some aspects, providing component 816 is configured to, based on a randomly selected evaluator decision value being greater than or equal to an evaluator decision threshold value, provide a respective evaluation output to a second LM with a prompt to generate a respective label associated with the respective evaluation output, such as performed for block 710 of FIG. 7.

In certain aspects, receiving component 818 is configured to receive a respective evaluation output from the first LM, such as performed for block 706 of FIG. 7. In some aspects, receiving component 818 is configured to receive, from the second LM, the respective label associated with the respective evaluation output, such as performed for block 712 of FIG. 7.

In certain aspects, selecting component 820 is configured to randomly select an evaluator decision value from a defined range of evaluator decision values, such as performed for block 708 of FIG. 7.

In certain aspects, decreasing component 822 is configured to decrease the evaluator decision threshold value, such as performed for block 714 of FIG. 7.

In certain aspects, determining component 824 is configured to determine a performance score for the first LM based on a plurality of labels comprising the respective labels, each label of the plurality of labels being associated with an evaluation input of the plurality of evaluation inputs, such as performed for block 716 of FIG. 7.

In certain aspects, external dataset 826 may include the external dataset described herein with respect to, for example, FIG. 3 and FIG. 4.

In certain aspects, and training data 828 may include the fine-tuning dataset described herein with respect to FIG. 3.

Note that FIG. 8 is just one example of a processing system consistent with aspects described herein, and other processing systems having additional, alternative, or fewer components are possible consistent with this disclosure.

### Example Clauses

Implementation examples are described in the following numbered clauses:

Clause 1: A method, comprising: initializing an evaluator decision threshold value; for each respective evaluation input of a plurality of evaluation inputs: providing the respective evaluation input to a first LM; receiving a respective evaluation output from the first LM; randomly selecting an evaluator decision value from a defined range of evaluator decision values; based on the randomly selected evaluator decision value being greater than or equal to the evaluator decision threshold value, providing the respective evaluation output to a second LM with a prompt to generate a respective label associated with the respective evaluation output; receiving, from the second LM, the respective label associated with the respective evaluation output; and decreasing the evaluator decision threshold value; and determining a performance score for the first LM based on a plurality of labels comprising the respective labels, each label of the plurality of labels being associated with an evaluation input of the plurality of evaluation inputs.

Clause 2: The method of Clause 1, wherein determining the performance score for the first LM comprises calculating a mean of a plurality of Boolean values associated with a plurality of evaluation outputs for the plurality of evaluation inputs.

Clause 3: The method of any one of Clauses 1-2, further comprising, based on the performance score for the first LM being greater than or equal to a threshold performance score, determining that the first LM is approved for a defined use case.

Clause 4: The method of any one of Clauses 1-3, wherein providing the respective evaluation output to the second LM with the prompt comprises, for at least one respective evaluation input of the plurality of evaluation inputs: generating a transformed prompt based on at least one of a modified complexity level or a modified reasoning dimension; and providing the transformed prompt to the second LM.

Clause 5: The method of any one of Clauses 1-4, wherein providing the respective evaluation output to the second LM with the prompt comprises, for at least one respective evaluation input of the plurality of evaluation inputs: determining at least one previously labeled evaluation input as being a comparable evaluation input comparable to the at least one respective evaluation input; retrieving a label associated with the comparable evaluation input; generating a transformed prompt based on the retrieved label; and providing the transformed prompt to the second LM.

Clause 6: The method of any one of Clauses 1-5, wherein providing the respective evaluation output to the second LM is further based on predicting, using an evaluator prediction component, that the second LM will generate an accurate label for the respective evaluation input.

Clause 7: The method of Clause 6, wherein predicting, using the evaluator prediction component, that the second LM will generate an accurate label for the respective evaluation input comprises: identifying a previously labeled evaluation input that is closest to the respective evaluation input based on a syntactic similarity level between the previously labeled evaluation input and the respective evaluation input; and based on the syntactic similarity level being greater than or equal to a threshold syntactic similarity level, predicting that the second LM will generate an accurate label for the respective evaluation input.

Clause 8: The method of Clause 6, wherein using the evaluator prediction component comprises using a third LM that is trained to predict whether the second LM will generate an accurate label for an evaluation input.

Clause 9: The method of Clause 6, wherein decreasing the evaluator decision threshold value comprises decreasing the evaluator decision threshold value by a defined amount based on an accuracy of the evaluator prediction component.

Clause 10: The method of any one of Clauses 1-9, wherein the second LM is selected between a human and the second LM based on a random selection for providing the respective evaluation output to.

Clause 11: A processing system, comprising: a memory comprising computer-executable instructions; and a processor configured to execute the computer-executable instructions and cause the processing system to perform a method in accordance with any one of Clauses 1-10.

Clause 12: A processing system, comprising means for performing a method in accordance with any one of Clauses 1-10.

Clause 13: A non-transitory computer-readable medium storing program code for causing a processing system to perform the steps of any one of Clauses 1-10.

Clause 14: A computer program product embodied on a computer-readable storage medium comprising code for performing a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
initializing an evaluator decision threshold value;
for each respective evaluation input of a plurality of evaluation inputs:
providing the respective evaluation input to a first language model (LM);
receiving a respective evaluation output from the first LM;
randomly selecting an evaluator decision value from a defined range of evaluator decision values;
based on the randomly selected evaluator decision value being greater than or equal to the evaluator decision threshold value, providing the respective evaluation output to a second LM with a prompt to generate a respective label associated with the respective evaluation output;
receiving, from the second LM, the respective label associated with the respective evaluation output; and
decreasing the evaluator decision threshold value; and
determining a performance score for the first LM based on a plurality of labels comprising the respective labels, each label of the plurality of labels being associated with an evaluation input of the plurality of evaluation inputs.

2. The method of claim 1, wherein determining the performance score for the first LM comprises calculating a mean of a plurality of Boolean values associated with a plurality of evaluation outputs for the plurality of evaluation inputs.

3. The method of claim 1, further comprising, based on the performance score for the first LM being greater than or equal to a threshold performance score, determining that the first LM is approved for a defined use case.

4. The method of claim 1, wherein providing the respective evaluation output to the second LM with the prompt comprises, for at least one respective evaluation input of the plurality of evaluation inputs:
generating a transformed prompt based on at least one of a modified complexity level or a modified reasoning dimension; and
providing the transformed prompt to the second LM.

5. The method of claim 1, wherein providing the respective evaluation output to the second LM with the prompt comprises, for at least one respective evaluation input of the plurality of evaluation inputs:
determining at least one previously labeled evaluation input as being a comparable evaluation input comparable to the at least one respective evaluation input;
retrieving a label associated with the comparable evaluation input;
generating a transformed prompt based on the retrieved label; and
providing the transformed prompt to the second LM.

6. The method of claim 1, wherein providing the respective evaluation output to the second LM is further based on predicting, using an evaluator prediction component, that the second LM will generate an accurate label for the respective evaluation input.

7. The method of claim 6, wherein predicting, using the evaluator prediction component, that the second LM will generate an accurate label for the respective evaluation input comprises:
identifying a previously labeled evaluation input that is closest to the respective evaluation input based on a syntactic similarity level between the previously labeled evaluation input and the respective evaluation input; and
based on the syntactic similarity level being greater than or equal to a threshold syntactic similarity level, predicting that the second LM will generate an accurate label for the respective evaluation input.

8. The method of claim 6, wherein using the evaluator prediction component comprises using a third LM that is trained to predict whether the second LM will generate an accurate label for an evaluation input.

9. The method of claim 6, wherein decreasing the evaluator decision threshold value comprises decreasing the evaluator decision threshold value by a defined amount based on an accuracy of the evaluator prediction component.

10. The method of claim 1, wherein the second LM is selected between a human and the second LM based on a random selection for providing the respective evaluation output to.

11. A processing system, comprising: one or more memories comprising computer-executable instructions; and one or more processors configured to execute the computer-executable instructions and cause the processing system to:
initialize an evaluator decision threshold value;
for each respective evaluation input of a plurality of evaluation inputs:
provide the respective evaluation input to a first language model (LM);
receive a respective evaluation output from the first LM;
randomly select an evaluator decision value from a defined range of evaluator decision values;
based on the randomly selected evaluator decision value being greater than or equal to the evaluator decision threshold value, provide the respective evaluation output to a second LM with a prompt to generate a respective label associated with the respective evaluation output;
receive, from the second LM, the respective label associated with the respective evaluation output; and
decrease the evaluator decision threshold value; and
determine a performance score for the first LM based on a plurality of labels comprising the respective labels, each label of the plurality of labels being associated with an evaluation input of the plurality of evaluation inputs.

12. The processing system of claim 11, wherein to cause the processing system to determine the performance score for the first LM, the one or more processors are configured to cause the processing system to calculate a mean of a plurality of Boolean values associated with a plurality of evaluation outputs for the plurality of evaluation inputs.

13. The processing system of claim 11, wherein the one or more processors are further configured to cause the processing system to, based on the performance score for the first LM being greater than or equal to a threshold performance score, determine that the first LM is approved for a defined use case.

14. The processing system of claim 11, wherein to cause the processing system to provide the respective evaluation output to the second LM with the prompt, the one or more processors are configured to cause the processing system to, for at least one respective evaluation input of the plurality of evaluation inputs:
generate a transformed prompt based on at least one of a modified complexity level or a modified reasoning dimension; and
provide the transformed prompt to the second LM.

15. The processing system of claim 11, wherein to cause the processing system to provide the respective evaluation output to the second LM with the prompt, the one or more processors are configured to cause the processing system to, for at least one respective evaluation input of the plurality of evaluation inputs:
determine at least one previously labeled evaluation input as being a comparable evaluation input comparable to the at least one respective evaluation input;
retrieve a label associated with the comparable evaluation input;
generate a transformed prompt based on the retrieved label; and
provide the transformed prompt to the second LM.

16. The processing system of claim 11, wherein to cause the processing system to provide the respective evaluation output to the second LM, the one or more processors are configured to cause the processing system to provide the respective evaluation output to the second LM further based on predicting, using an evaluator prediction component, that the second LM will generate an accurate label for the respective evaluation input.

17. The processing system of claim 16, wherein to cause the processing system to predict, using the evaluator prediction component, that the second LM will generate an accurate label for the respective evaluation input, the one or more processors are configured to cause the processing system to:
identify a previously labeled evaluation input that is closest to the respective evaluation input based on a syntactic similarity level between the previously labeled evaluation input and the respective evaluation input; and
based on the syntactic similarity level being greater than or equal to a threshold syntactic similarity level, predict that the second LM will generate an accurate label for the respective evaluation input.

18. The processing system of claim 16, wherein the evaluator prediction component comprises using a third LM that is trained to predict whether the second LM will generate an accurate label for an evaluation input.

19. The processing system of claim 16, wherein to cause the processing system to decrease the evaluator decision threshold value, the one or more processors are configured to cause the processing system to decrease the evaluator decision threshold value by a defined amount based on an accuracy of the evaluator prediction component.

20. The processing system of claim 11, wherein the second LM is selected between a human and the second LM based on a random selection for providing the respective evaluation output to.
